(19) United States
(12) Patent Application Publication
(10) Pub. No.: US 2014/0347474 A1
(43) Pub. Date: Nov. 27, 2014

(54) Device and method for monitoring the cutting edge sharpness

(71) Applicant: CLAAS AGROSYSTEMS KGAA MBH & CO KG, GUETERSLOH (DE)

(72) Inventor: Tommy Ertbolle Madsen, Virum (DK)

(73) Assignee: CLAAS AGROSYSTEMS KGAA MBH & CO KG, GUETERSLOH (DE)

(21) Appl. No.: 14/281,116

(22) Filed: May 19, 2014

(30) Foreign Application Priority Data
May 22, 2013 (EP) 13002675.0

(51) Int. Cl. A01D 41/127; G06K 9/46; H04N 5/225; G06T 7/00

(52) U.S. Cl. CPC A01D 41/127; G06T 7/0004; G06K 9/4604; H04N 5/2252
USPC 348/135

(57) ABSTRACT

A device for monitoring the cutting edge sharpness of a knife is provided with a light source for illuminating the knife and a camera for recording images of the knife. The light source projects at least one reference line onto the knife. In the field of vision of the camera, the reference line crosses the cutting edge of the knife. The cutting edge sharpness of the knife is estimated by the shape of the reference line in an image that captures the knife and its cutting and is recorded by the camera.

### CROSS-REFERENCE TO A RELATED APPLICATION

The invention described and claimed hereinbelow is also described in European Priority Document EP 13 002675.0, filed on May 22, 2013. The European Priority Document, the subject matter of which is incorporated herein by reference, provides the basis for a claim of priority of invention under 35 U.S.C. 119(a)-(d).

### BACKGROUND OF THE INVENTION

The present invention relates broadly to a device for monitoring the cutting edge sharpness of a knife, more particularly relates to a rotating knife on a knife drum of a harvesting machine, such as a field shredder, a baler or like harvesting machine.

EP 1 522 214 D1 discloses a device for monitoring the cutting edge sharpness of a knife comprising a light source for illuminating the knife, a camera for taking images of the knife illuminated by the light source and a monitoring device. In the monitoring device, the images of the camera are subjected to an image processing in order to evaluate the sharpness of the cutting edges of the knife by comparison with a desired shape. The view direction of the camera is substantially orientated radially to the axis of the drum carrying the knives, so that the cutting edge of the knife projecting towards the camera in the images of the camera substantially appears only as a thin line between two areas each corresponding to flanks of the knife. Getting blunt of the cutting edge does not influence the shape with which the knife appears in the images of the camera, but merely the width of the line between the two flanks. This makes a precise evaluation of the cutting edge sharpness difficult.

### SUMMARY OF THE INVENTION

The present invention overcomes the shortcomings of known arts, such as those mentioned above.

To that end, the present invention provides a device for monitoring the cutting edge sharpness of a knife by which a safe and reliable evaluation of the cutting edge sharpness is possible.

In an embodiment, the invention comprises a device for monitoring the cutting edge sharpness of a knife with a light source for illuminating the knife and a camera for taking images of the knife. The light source is equipped to project at least one reference line crossing the cutting edge of the knife in the field of vision of the camera and the contour line is evaluated for generating a dimension for the cutting edge sharpness. The reference line follows the contour of the knife and therefore has a curvature in the region of the cutting edge, which is directly connected to the curvature radius and consequently to the sharpness of the cutting edge. By examining the profile of the reference line in the images supplied by the camera, the sharpness of the cutting edge can therefore be reliably evaluated quantatively.

Preferably, the reference line is an illuminated line flanked on both sides by non-illuminated regions. Such a reference line can be projected in that light of the light source passes through a slit-shaped aperture.

A sharp boundary between an illuminated and a non-illuminated region of the knife also can serve as reference line. Such a boundary can be obtained by shading a part of the light of the light source on a preferentially straight edge.

The reference line in the form of an illuminated line also can be obtained, in that on the path of the light from the light source to the knife, a cylindrical optical element such as a cylindrical lens or a cylindrical mirror or a rotating optical element is arranged. When the light source generates a widely fanned-out light cone (in the case of an incandescent light source), the cylindrical optical element serves for focusing the light cone onto the linear illuminated region.

Also, where the light source generates a sharply bundled beam, the cylindrical optical element can then project the reference line in that it fans out the bundled beam in a plane.

With the help of a rotating optical element, the reference line is projected over the course of a monitoring period in that the bundled beam of the light source is moved over the knife. It is not required that the reference line at any time is entirely visible. It is sufficient if the bundled beam during the course of a revolution of the rotating element gradually draws the reference line onto the knife. In particular, a laser is suitable as light source for generating a sharply bundled light beam.

In order to be able to perform sharpness measurements on a moving knife it is practical when the camera can operate with short shutter speeds.

If the light source generates light outside shutter speeds of the camera, it cannot be utilised for the sharpness measurement. For an energy-efficient operation it is practical if the light source is pulsed. A pulsed light source additionally makes possible a measurement on the moving knife even when the shutter speeds of the camera are long compared with the pulse duration of the light source and too long for freezing the knife movement.

When the knife is mounted on a rotating drum in the manner usual with harvesting machines, a triggering device for synchronising the operation of the camera and/or of the pulsed light source is coupled to the rotation of the drum. Thus, images are obtained in which the position of the cutting edge is reproducible and predictable. For an image processing device connected downstream, this simplifies the search for the cutting edge in the images supplied by the camera and thereby reduces the processing effort.

The light source and the camera are preferentially mounted on a support that can be moved along the cutting edge. By moving the support, the reference line is shifted along the cutting edge of the knife and the cutting edge sharpness is determined for numerous points of the cutting edge. By averaging measurement values of the cutting edge sharpness for different points of a cutting edge (or of a plurality of cutting edges of a same drum), a faulty evaluation is avoided which might otherwise occur if the measurement takes place on a knick of the knife alone.

The triggering device can be mounted to the same support as the light source and the camera in order to be movable along the cutting edge together with these. In this way it can be ensured that the cutting edge of the knife in the images supplied by the camera is always located in the same location even when the knife is orientated skewed to the drum axis.

The light source and/or the camera are accommodated in a housing that can be loaded with pressurised gas. Owing to the fact that the pressurised gas flows out of the housing, in particular, in the direction of the knife to be examined, the advancing of material to be cut into the housing and a contamination of the optical surfaces of light source and/or camera by the material to be cut is prevented or at least limited.

In the same way, a movable shutter element, which can be placed between light source and knife and/or between camera and knife, limit the dirt accumulation on the optical surfaces of light source and camera.

In order for the curvature of the reference line on the cutting edge to become clearly visible in the images supplied by the camera, the direction of incidence from which the light of the light source strikes the cutting edge and the view direction of the camera define an angle of at least 45°, a maximum of 135°, and preferably, an angle of between 60° and 90°.

The invention also provides for monitoring the cutting edge sharpness of a knife. The method includes steps of projecting at least one reference line onto the knife which crosses the cutting edge of the knife, recording an image of the reference line and estimating the cutting edge sharpness by the shape of the reference line in the recorded image.

### BRIEF DESCRIPTION OF THE DRAWINGS

Further features and advantages of the invention will become apparent from the description of embodiments that follows, with reference to the attached figures, wherein:

FIG. 1 presents a schematic view of a harvesting machine embodying a field shredder configured according to the invention;

FIG. 2 provides a perspective view of a shredder drum and a device arranged thereon for monitoring the cutting edge sharpness according to the invention;

FIG. 3 presents a schematic view of a knife from the perspective of a camera of the device for the cutting edge sharpness monitoring;

FIG. 4 presents an example of an image supplied by the camera of the device for the cutting edge sharpness monitoring;

FIG. 5 a schematic section through a device for monitoring the cutting edge sharpness through a device that can be moved along a knife to be examined; and

FIG. 6 present a schematic view of a cutting edge sharpness monitoring device displaceably held on a rail extending parallel to the axis of rotation of a shredder drum.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

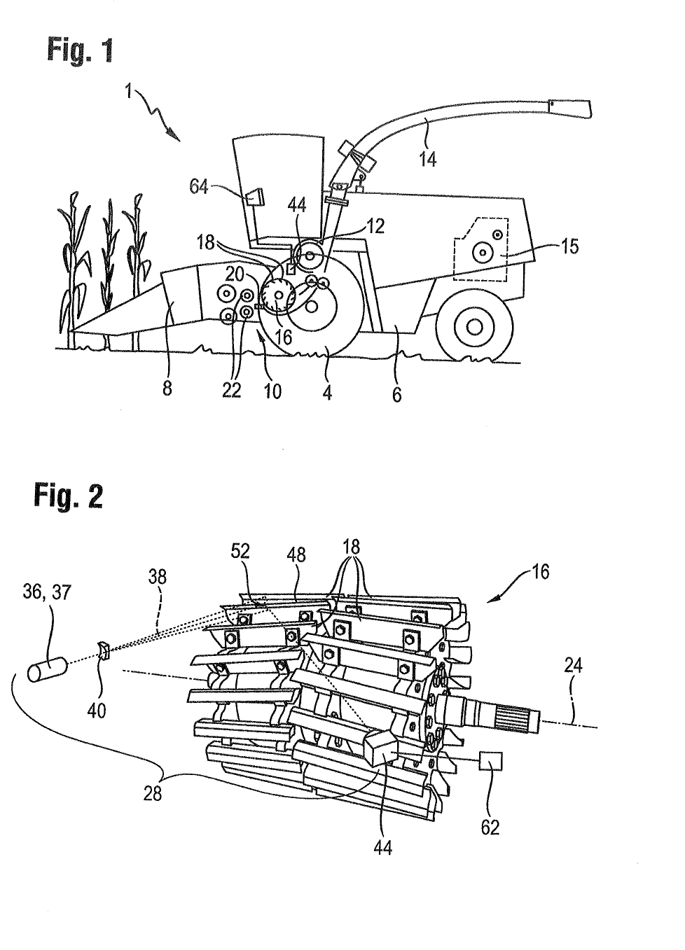

FIG. 1 shows a field shredder 1 with a device for the cutting edge sharpness monitoring designed according to the present invention. The field shredder 1 is equipped with a chassis comprising a wheel 4, a vehicle frame 6 and a mounting attachment 8 mounted to the front of a vehicle frame 6, which serves for picking up harvest material from the ground and feeding said harvest material into a conveying channel and within the frame 6. The field shredder also includes a shredding unit 10, a post-accelerator 12 and a discharge spout 14, which are arranged one after the other on the conveying channel, and a motor 15 for driving the wheel and the movable parts of the pick-up attachment 8, of the shredder unit 10 and of the post-accelerator 12.

The pick-up attachment 8 of the field shredder 1 is exchangeable. In FIG. 1, the pick-up attachment 8 is a corn cutter. In its place, other types of attachments, for example, for the mowing of standing green plants or for picking up hay lying in swathes can be mounted.

The shredder unit 10 comprises a rotationally driven shredder drum 16, which is put onto shredder knives 18 evenly distributed over its circumference. The rotating shredder knives 18 form a cutting gap together with a fixed-location counterpart cutting edge 20, in which fed-in harvest material is cut with the help of conveying rollers 22.

FIG. 2 depicts the shredder drum 16, wherein the shredder knives 18 each extend only over a left or a right half of the shredder drum 16 and are each offset with respect to one another in circumferential direction on a centre plane of the shredder drum 16 by half a knife spacing each. Apart from this, the cutting edges 48 of the shredder knives 18 are orientated skewed with respect to an axis of rotation 24 of the shredder drum 16. Consequently, during the course of the rotation of the shredder drum 16, the points on which the shredder knives 18 and the fixed-location counterpart cutting edge 20 cross each other move in the axial direction. Owing to the fact that the shredder knives 18 thus only cut in a point each, the risk of a blockage of the shredder drum 16 through excessive feeding of harvest material is reduced.

A device 28 for monitoring the cutting edge sharpness of the shredder knives 18 comprises a light source 36 (a laser 37 in the embodiment shown) and a camera 44. The laser 37 emits a beam 38 in the direction of one of the shredder knives 18. A beam-forming optical device, here a cylindrical lens 40, is arranged between the laser 37 and the shredder knife 18 in order to fan out the beam 38 in a plane which crosses the shredder knife 18. The fanned-out beam 38 illuminates a reference line 52 on the surface of the shredder knife 18, which crosses the cutting edge 48 of the shredder knife 18. The camera 44 is arranged in order to monitor the reference line 52 at a non-zero angle to the plane of the fanned-out beam 38, typically at an angle between 45 and 135°.

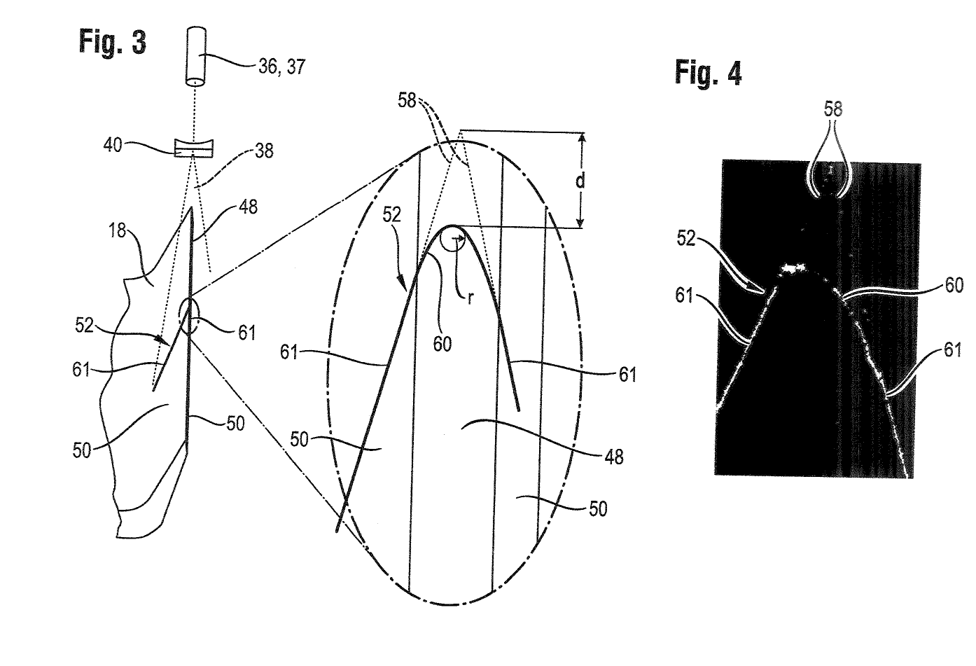

In its left part, FIG. 3 shows the shredder knife 18 and the reference line 52 projected thereon from the viewing angle of the camera 44. Seen from this direction, the profile of the reference line 52 mirrors the cross section of the shredder knife 18. The shredder knife has two flat flanks 50 on both sides of the cutting edge 48, a straight-line portion 61 of the reference line each extends and on both flanks 50.

The right part of FIG. 3 shows an enlarged detail of the shredder knife 18 with the reference line 52. Here it is visible that the cutting edge 48 has a non-zero width and that the linear portions 61 do not cross each other on the cutting edge 48 at an acute angle, but are connected through an arch-shaped portion 60.

An image evaluation unit 62 (see FIG. 2) connected to the camera 44 is provided, in order to evaluate the sharpness of the cutting edge 48 using the profile of the reference line 52, in particular of its arch-shaped portion 60 in the images supplied by the camera 44.

Such a sharpness evaluation can for example include the calculation of the smallest curvature radius r of the arch-shaped portion 60. The smaller the determined curvature radius r, the sharper is the cutting edge 48. When the smallest curvature radius r exceeds a limit value, it can be concluded from this that the cutting edge 48 is blunt and has to be ground.

Another possibility is to extrapolate the linear portions 61 of the reference line 52 linearly up to a crossing point in the image evaluation unit 62, as is shown in FIG. 3, through dotted lines 58, and to calculate the spacing d between the point of intersection of the lines 58 and the apex of the arch-shaped portion 60 or the spacing between the point of intersection of the lines 58 and the point of the arch 60 which is next adjacent. Here, too, a large value of the spacing d indicates a blunt cutting edge 48, so that when the spacing d exceeds a limit value, regrinding is practical.

The reference line 52 need not completely be within the field of vision of the camera 44. It is obviously sufficient when the camera 44 in each case is only able to see a part of the linear portions 61, which is long enough in order to be able to determine and extrapolate the direction of the portions 61. For calculating the smallest curvature radius r it is even sufficient when only the arch 60 is included in the images of the camera 44.

FIG. 4 shows a real image supplied by the camera 44 for illustration. An intensive but because of the wear of the shredder knife 18 irregular right line is the reference line 52 projected onto the knife 18 by the laser 37. The linear portions 61 running on the flanks 50 have to be clearly distinguished from the arch 60 connecting them. Two thin lines 58 are added by the image evaluation unit 62 in extension of the linear portions 61 in order to determine the crossing point from which the spacing d to the arch 60 is then determined.

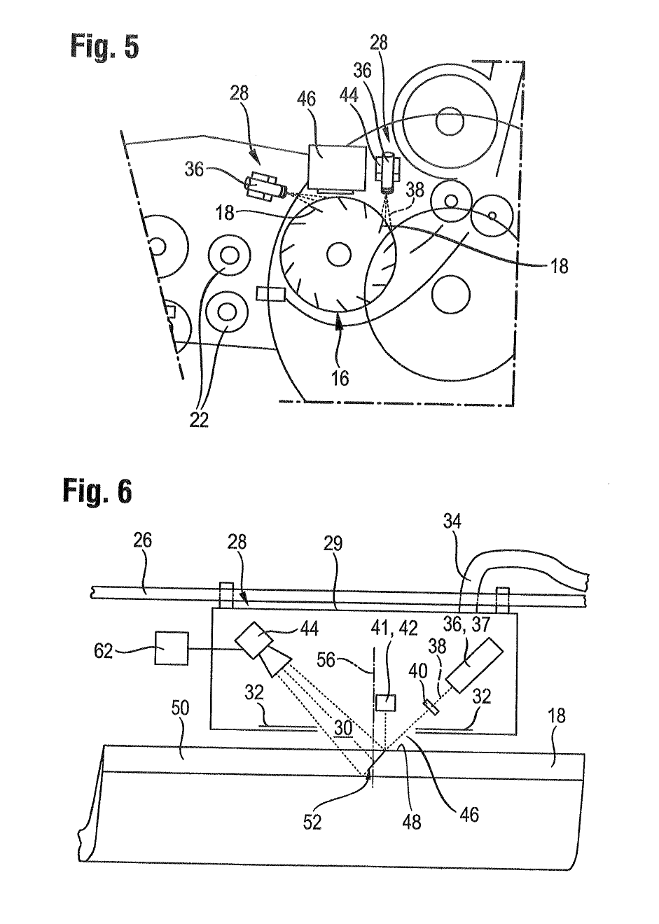

FIG. 5 is presented to highlight possibilities of attaching the cutting edge sharpness monitoring device 28 in the field shredder 1, using an enlarged detail from FIG. 1. Generally, the light source 36 and the camera 44 are arranged outside the path of the shredded material, i.e., on an upper half of the shredding drum 16, so that the shredded material does not block the path of the light and prevent a measurement. Since space also is generally required there for a grinding device 46 for sharpening the knives 18, the cutting edge sharpness monitoring device 28 may be accommodated, based on the direction of rotation of the shredder drum 16 (in anti-clockwise direction in FIG. 5), proximate to the shredder drum circumference in front of the grinding device 46, so that consequently the light source 36 shines obliquely from the top onto a shredder knife 18 moving upwards, or, the cutting edge sharpness monitoring device 28 can be placed over the conveying rollers 22 so that the light source 36 illuminates a forward moving shredder knife 18 obliquely from the front.

According to a configuration shown in FIG. 6, the cutting edge sharpness monitoring device 28 is displaceably held on a rail 26 extending parallel to the axis of rotation 24 of the shredder drum 16. The light source 36, i.e., the laser 37, the cylindrical lens 40, the camera 28 and a triggering device 41 (here in the form of a knife sensor 42), are accommodated in a housing 29 guided on the rail 26. Light source 36 and camera 44 can alternatively be accommodated in separate housings, but these should be displaceable jointly and at a fixed position with respect to each other along the rail 36 so that the reference line 52 is always in the field of vision of the camera 44.

On a lower side facing the shredder drum 16, the housing 29 has a lockable opening 30. In the FIG. 6 representation, two wings 32 are schematically shown to be displaceably guided in parallel in rails (not shown). The wings are positioned in front of the opening 30 in order to close off the openings, preferably tightly, while the device 28 is not in use and to protect the interior of the housing 29 from the entry of shredded material, flying sparks during a possible regrinding of the shredder knives 18 and other contaminations.

The closing of the opening 30 can be sufficient for protecting the housing interior from contamination, when cutting edge sharpness measurements are carried out with stationary drum 16. However, in order to minimise work interruptions of the vehicle, it is preferred to perform cutting edge sharpness measurements while the drum 16 runs in shredding mode. In order to prevent or to minimise shredded material entering the housing 29 also in this case, the housing 29 is connected to a compressed-air source via a flexible hose 34. When the opening 30 is opened for measuring, the compressed air supplied via the hose 34 exits from the housing 29 via said opening, thus keeping flying shredded material away from the interior of the housing 29.

The cylindrical lens 40 and the camera 44 are located on different sides of an imaginary plane 56 running perpendicularly to the cutting edge 48 and through the illuminated surface region 52. The propagation plane of the beam 38 and the direction, from which the camera 44 views the cutting edge 48, define an angle α of in this case approximately 90°.

When for examining a shredder knife 18 of the drum 16 for its cutting edge sharpness the rotation of the shredder drum 16 is stopped, the device 28 is displaced on the shredder knife 18 concerned along the rail 26. Consequently, the light source projects the reference line 52 in different locations of the shredder knife 18 and the camera 44 records images of the respective reference line 52 projected there, by which the sharpness of the cutting edge 48 on the respective illuminated location can be recorded. Practically, the values so recorded are averaged prior to the comparison with the reference value in order to prevent that an individual unusually severely or unusually mildly worn location of the cutting edge 48 is used as a base for deciding on regrinding.

The image evaluation unit 62 makes the decision regarding the necessity of the regrinding directly by the determined value of the cutting edge sharpness and if necessary, put the grinding device 46 in operation. Alternatively, only the result of the measurement can be passed on to a display instrument 64 (see FIG. 1) in the driver's cab of the field shredder in order to leave the decision regarding the regrinding to the driver.

In practice, it is preferred to perform the monitoring of the cutting edge sharpness on the rotating drum 16. Any blurriness of the generated images resulting from the movement of the knife 18 in such a case is limited in that an adequately short shutter speed of the camera 44 (preferentially not more than 5 μs at a rotational speed of the shredder drum of 1,200 rpm) is used and/or in that the light source 36 is operated in a pulsed manner. In particular, when the light source 36 as mentioned above is the laser 37, pulse durations of the order of magnitude of microseconds or less can be realised without problem.

The knife sensor 42 is provided in order to record the passage of a shredder knife 18 through a given point in front of the opening 30 of the housing 29 and thereupon trigger the camera 44 for recording an image or, in the case that the light source 36 operates in a pulsed manner, to generate a light impulse. In the configuration of FIG. 6, the knife sensor 42 is arranged in order to record the passage exactly of that region of the cutting edge 48 of a shredder knife 18, on which the reference line 52 is then projected by the light source 36.

Such operation ensures that the reference line 52 in the images of the camera 44 is always located in the same place irrespective of whether the device 28 is located on the left or the right half of the shredder drum 16 and, how severely skewed if applicable the shredder knives 18 are orientated. Alternatively, two knife sensors 42 on the left and right of the position of the knife senor 42 shown in FIG. 3 are provided, of which the one is utilised while the device 28 is located on the left half of the shredder drum 16 and the other one is utilised when the device is located on the right half.

It also is possible to use an angle of rotation sensor directly arranged on the axis of the shredder drum 16 as triggering device 41 for the image generation. In such case, however, the skewed position of the shredder knives 18 must be taken into account through a variable delay between the triggering signal of the angle of rotation sensor and the image generation as a function of the position of the device 28 along the axis 24.

In order to perform an examination of the cutting edge sharpness on all knives 18 of the drum 16, the device 28 is displaced continuously along the rail 26 over the entire length of the drum 16 and in the process record an image with each passage of a knife 18 in front of the device 28. Since the detected knives 18 periodically recur in the sequence of the images supplied by the camera 44 it is possible in the image evaluation unit 62 to assign the images in each case to the knife 18 depicted in these and subsequently evaluate the cutting edge sharpness of this knife by the plurality of images obtained for a given knife 18 and to individually take the decision regarding the need of regrinding for each knife. However, an assignment of the images to the individual knives 18 can be omitted and instead an average value calculated via all cutting edge sharpness values derived from the images and instead of this average value a uniform decision regarding the regrinding for all knives 18 of the drum 16 be taken. Thus, the frequency with which the harvest operation has to be interrupted for regrinding the knives 18 can be reduced, which altogether makes possible a more efficient harvesting operation.

### LIST OF REFERENCE NUMBERS

1 Field shredder
4 Chassis
5 Vehicle frame
8 Pick-up attachment
10 Shredder unit
12 Post-accelerator
14 Discharge spout
15 Motor
16 Shredder drum
18 Shredder knife
20 Counterpart cutting edge
22 Conveying roller
24 Axis of rotation
26 Rail
28 Device
29 Housing
30 Opening
32 Wing
34 Hose
36 Light source
37 Laser
38 Beam
40 Cylindrical lens
41 Triggering device
42 Knife sensor
44 Camera
46 Grinding device
48 Cutting edge
50 Flank
51 Line
52 Reference line
56 Plane
58 Leg
60 Arch-shaped portion
61 Linear portion
62 Image evaluation unit
64 Display instrument

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A device for monitoring the cutting edge sharpness of a knife, comprising:
a knife;
a light source for illuminating the knife; and
a camera for recording images of the knife;
wherein the light source is configured to project at least one reference line onto the knife that crosses a cutting edge of the knife in a field of vision of the camera, and a contour of the line is evaluated for generating a dimension for the cutting edge sharpness.

2. The device according to claim 1, wherein the reference line is an illuminated line flanked on both sides by non-illuminated regions.

3. The device according to claim 2, further comprising a cylindrical optical element or a rotating optical element in the path of the light from the light source to the knife.

4. The device according to claim 1, wherein the light source is a laser.

5. The device according to claim 1, wherein the light source is pulsed.

6. The device according to claim 1, wherein the knife is mounted on a rotating drum and wherein a triggering device for synchronising the operation of the camera, the pulsed light source or both, is functionally coupled to the rotation of the drum.

7. The device according to claim 1, wherein the light source and the camera are mounted on a support that is movable along the cutting edge.

8. The device according to claim 6, wherein the triggering device is mounted on the support.

9. The device according to claim 7, wherein the common support is a housing in which the light source and the camera are positioned.

10. The device according to claim 1, further comprising a movable shutter element interposed between light source and the knife, between the camera and the knife or both.

11. The device according to claim 1, wherein the light source, the camera or both are accommodated in a housing that can be loaded with pressurised gas.

12. The device according to claim 1, wherein the direction of incidence of the light onto the cutting edge and the viewing direction of the camera onto the cutting edge defines an angle (α) of at least 45 and a maximum of 135°.

13. The device according to claim 12, wherein the angle (α) is between 60 and 90°.

14. A method for monitoring the cutting edge sharpness of a knife, comprising the steps:
projecting at least one reference line onto the knife that crosses a cutting edge of the knife,
recording an image of the reference line, and
estimating the cutting edge sharpness by the shape of the reference line in the recorded image.
